(19) United States
(12) Patent Application Publication
(10) Pub. No.: US 2025/0304253 A1
(43) Pub. Date: Oct. 2, 2025

(54) INFLATABLE BLADDER FOR AIRCREW ANTI-G GARMENT

(71) Applicant: RFD Beaufort Limited, Ellesmere Port (GB)

(72) Inventor: Paul OLIVER, Rhyl, Denbighshire (GB)

(21) Appl. No.: 18/864,494

(22) PCT Filed: May 5, 2023
(86) PCT No.: PCT/EP2023/062001

§ 371 Date: Nov. 8, 2024

(30) Foreign Application Priority Data
May 10, 2022 (GB) 2206837.3

(51) Int. Cl. B64D 10/00

(52) U.S. Cl. CPC B64D 10/00; B64D 2010/002

(57) ABSTRACT

An inflatable bladder configured to be carried by an aircrew garment worn on the body of the aircrew and to apply pressure to the body when inflated by a gas to counteract effects of high G-forces during flight. the bladder includes a gas-permeable material allowing the passage of the gas therethrough to cool the body

### TECHNICAL FIELD

The invention relates to an inflatable bladder configured to be carried by an aircrew garment worn on the body of the aircrew and to apply pressure to the body when inflated by a gas to counteract effects of high G-forces during flight. The invention also relates to aircrew ensembles worn by aircrew in flight and to a method of cooling aircrew.

### BACKGROUND TO THE INVENTION

Aircrew such as pilots wear an ensemble including a protective suit when flying in aircraft. Traditionally the suit is either a single piece suit combining both jacket and trousers in a single garment or it is a two-piece suit with a separate jacket and trousers.

The ensemble may include also special equipment (aircrew life support equipment-ALSE) that protects the wearer against the effects of high G-acceleration or altitude and other potentially damaging factors. In this case, the ensemble provides an outer layer that holds and positions and restrains inflatable counter pressure bladders. These bladders can provide counter pressure to the legs when the wearer is being accelerated to reduce the effect of blood pooling in the lower limbs and/or can provide counter pressure to the chest to counteract the effect of breathing pressurised gas when at altitude. Examples of this are shown in WO-A-2007/111981 and in US-A-6325754.

An inflatable chest counter pressure bladder is either incorporated into a vest or a jacket type garment which is worn by the pilot over the flight suit, or the bladder is incorporated into the jacket part of the flight suit. Inflatable lower G bladders are either incorporated into a lower G garment, which is typically worn over the flight suit, or the bladders are incorporated into the trouser section of the flight suit.

In some cases the bladders are made of a textile (nylon or polyester) which is coated with an air-holding layer of an air impermeable material such as synthetic rubber (e.g. neoprene) or thermo-plastic materials such as polyurethane (PU). Most bladders are now made of a PU coated fabric type because PU is a thermo-plastic material which can be easily welded using high frequency or radio frequency or ultrasonic welding. (Materials such as neoprene need to be glued using a solvent-based adhesive which is labour intensive and has health and safety problems.)

There are broadly two types of lower G bladder assemblies. First, there is a full cover bladder assembly where the inflatable area of the bladder coverage is almost all of the lower limbs and abdomen. Such an inflatable bladder assembly can also be connected at ankle level to an inflatable lining of a flight boot or an inflatable sock lining the boot, or the boot can incorporate an inflatable lining. The counter pressure can be applied directly to the limbs by providing the assembly with a restraining cover with the bladder inflating underneath the restraining and cover the restraining cover allowing the expansion of the bladder only in a direction towards the limbs. Secondly, there is a partial cover bladder assembly (also called a “skeletal” or “five bladder” assembly). In this case two or more bladders (up to 5) cover respective parts of the lower body and are positioned for example, over the leg bone (hence skeletal) and also have a bladder area over the abdomen. In this case, each bladder applies tension to a restraining cover of the assembly as it inflates, which in turn then applies the counter pressure to the limbs through the tensioned cover material.

Such bladder assemblies can be integrated into the trousers of a suit rather than being incorporated into a separate garment, as shown in WO-A-2007/111981.

Counter pressure assemblies whether jackets or vests or lower G bladder assemblies of the above types have a problem of placing an excessive thermal burden on the wearer. The full cover lower G assembly is the worst in terms of the thermal burden and also has a problem of being excessively bulky. Excessive thermal burden and the consequent hyperthermia on the aircrew increases their fatigue as well as sweat loss and dehydration and reduces aircrew concentration and mission endurance. Increased core temperature also reduces tolerance to the effects of high G acceleration.

WO-A-2021/043640 discloses anti-G trousers are partially double-walled and partially single-walled and made from a tear-resistant, refractory and stretch-resistant synthetic textile material of max. 130 gram/m2. The single-walled areas are air-permeable. In the double-walled areas, airtight pockets are thereby formed which act as pneumatic muscles and contract when being inflated from an automatic pressure supply and thereby draw the adjacent single-layer textile pieces towards one another.

WO-A-2012/041971 discloses an aircrew ensemble comprising a garment for covering at least a part of a body of a wearer and an inflatable counter-pressure bladder, carried by the garment. The inflatable counter-pressure bladder is formed from a moisture-vapour permeable material allowing the passage therethrough of perspiration from the wearer's body. Such moisture-vapour permeable materials are not air-permeable or gas-permeable.

### SUMMARY OF THE INVENTION

According to one aspect of the invention, there is provided an inflatable bladder configured to be carried by an aircrew garment worn on the body of the aircrew and to apply pressure to the body when inflated by a gas to counteract effects of high G-forces during flight, wherein the bladder includes a gas-permeable material allowing the passage of the gas therethrough to cool the body.

Advantageously, the same gas supply may be used to counteract effects of high G-forces and cool the body of the aircrew. Conveniently, the gas supply may be from a supply of air on an aircraft that is used to help the aircrew breathe.

The bladder is preferably configured to control the maximum rate of passage of the gas therethrough such that the bladder remains sufficiently inflated to counteract effects of high G-forces during flight.

The bladder may include a plurality of formations in the internal surface thereof to facilitate passage of the gas therebetween.

According to another aspect of the invention, there is provided aircrew ensemble comprising a garment for covering at least a part of a body of a wearer and an inflatable counter-pressure bladder, carried by the garment, the inflatable counter-pressure bladder being formed from a gas-permeable material allowing the passage therethrough of gas to cool the wearer's body.

An ensemble may be provided in combination with an inflation system for inflating the bladder when a threshold G-force is detected acting on the wearer's body, the inflation system also being operable in the absence of said threshold G-force to cause gas to pass through the gas-permeable material of the bladder to increase the cooling of the wearer's body. This advantageously allows cooling of the wearer in non-high-G situations.

According to a further aspect of the invention, there is provided method of a protecting aircrew, providing including an inflatable bladder configured to be carried by an aircrew garment worn on the body of the aircrew, wherein the bladder includes a gas-permeable material, and applying gas pressure to the bladder to cause the passage of the gas therethrough to cool the body of the aircrew.

Applying gas pressure to the bladder may apply pressure to the body of the aircrew when the bladder is inflated by the gas to counteract effects of high G-forces during flight.

### BRIEF DESCRIPTION OF THE DRAWINGS

For a better understanding of the present invention embodiments will now be described by way of example, with reference to the accompanying drawings, in which:

FIG. 1 is a general view of an aircrew ensemble including a chest counter-pressure assembly and full cover lower G assembly,

FIG. 2 is a section on the line X-X of FIG. 1,

FIG. 3 is a cross-section on the line Z-Z of FIG. 1,

FIGS. 4A and 4B are alternative partial cross-sections on the line X-X or Z-Z of FIG. 1 showing the passage of air through the lower G assembly in respective first and second different embodiments,

FIG. 5 is a similar view to FIG. 1 but showing a partial cover lower G assembly,

FIG. 6 is a cross-section on the line Y-Y of FIG. 5 through a lower G bladder of the assembly of FIG. 5,

FIGS. 7A and 7B are cross-sections on the line Z-Z of FIG. 1 showing, deflated and inflated respectively, a second form of lower G bladder of the assembly,

FIGS. 8A and 8B are cross-sections on the line Z-Z of FIG. 1 showing, deflated and inflated respectively, a third form of lower G bladder of the assembly,

FIG. 9 is a similar view to FIG. 1 but showing an aircrew ensemble with an alternative form of chest counter pressure assembly and full cover lower G assembly,

FIG. 10 is a schematic view of a grill bladder for the ensemble of FIG. 9,

FIG. 11 is a schematic view of a finger bladder for the ensemble of FIG. 9,

FIG. 12 is a cross-section on the line X-X of FIG. 9 showing the inflation of a chest bladder of the chest counter pressure assembly of FIG. 9,

FIGS. 13A and 13B are cross-sections on the line Y-Y of FIG. 9 showing a bladder of the lower G assembly respectively deflated (13A) and inflated (13B),

FIGS. 14A, 14B, 14C and 14D are partial cross-sectional views of an alternative embodiment of bladder for the ensemble of FIG. 9 in which the bladder is self-tightening, FIGS. 14A and 14C showing the bladder un-inflated and FIGS. 14B and 14D showing the bladder inflated,

FIG. 14E is a similar view to FIGS. 14A, 14B, 14C and 14D but showing a known non-self tightening bladder,

FIG. 15 is a similar view to FIG. 1 but showing an aircrew ensemble with detachable bladders,

FIG. 16A is a schematic view of a detachable chest bladder for the ensemble of FIG. 15,

FIG. 16B is a schematic view of a detachable leg bladder for the ensemble of FIG. 15,

FIG. 16C is a section on the line X-X of FIG. 16A and showing the bladder of FIG. 16A mounted on a jacket of the ensemble of FIG. 15,

FIG. 16D is a section on the line Y-Y of FIG. 16B and showing the bladder of FIG. 16B mounted on a lower G garment of the ensemble of FIG. 15,

FIG. 17 is a schematic side elevation of an aircrew in an ejector seat of an aircraft an wearing an ensemble for countering G forces of any on the kinds shown in FIGS. 1 to 16D and showing the flow of body fluids under G_{z} forces,

FIG. 18 is a section on the line X-X of FIG. 17 showing schematically blood vessels of the aircrew of FIG. 17 in an undistended position,

FIG. 19 is a similar view to FIG. 18 but showing the blood vessels in a distended position as a result of G_{z} forces,

FIG. 20 is a similar view to FIG. 19 and showing the effect of a full cover lower G garment,

FIG. 21 is a schematic section through part of a lower leg and ankle carrying an inflatable lower G assembly with inflation proceeding towards the ankle,

FIG. 22 is a similar view to FIG. 21 but showing inflation starting from the ankle,

FIG. 23 is a similar view to FIG. 22 but showing the progression of inflation from the ankle and the use of an inlet at the ankle,

FIG. 24 is a similar view to FIG. 23 and showing the further progression of inflation from the ankle,

FIG. 25 is a similar view to FIGS. 21 and 22 but showing the application of a residual pressure to the leg,

FIG. 26 is a schematic front elevation of an aircrew ensemble including a lower G bladder assembly providing the ankle inflation and residual pressure of FIGS. 22, 23 and 24 and showing a first form of air supply,

FIG. 27A is a similar view to FIG. 26 but showing a second form of air supply,

FIG. 27B is a section on the line X-X of FIG. 27A, and

FIG. 28 shows an example arrangement of holes in a bladder to provide air-permeability.

### DETAILED DESCRIPTION OF EMBODIMENT OF THE INVENTION

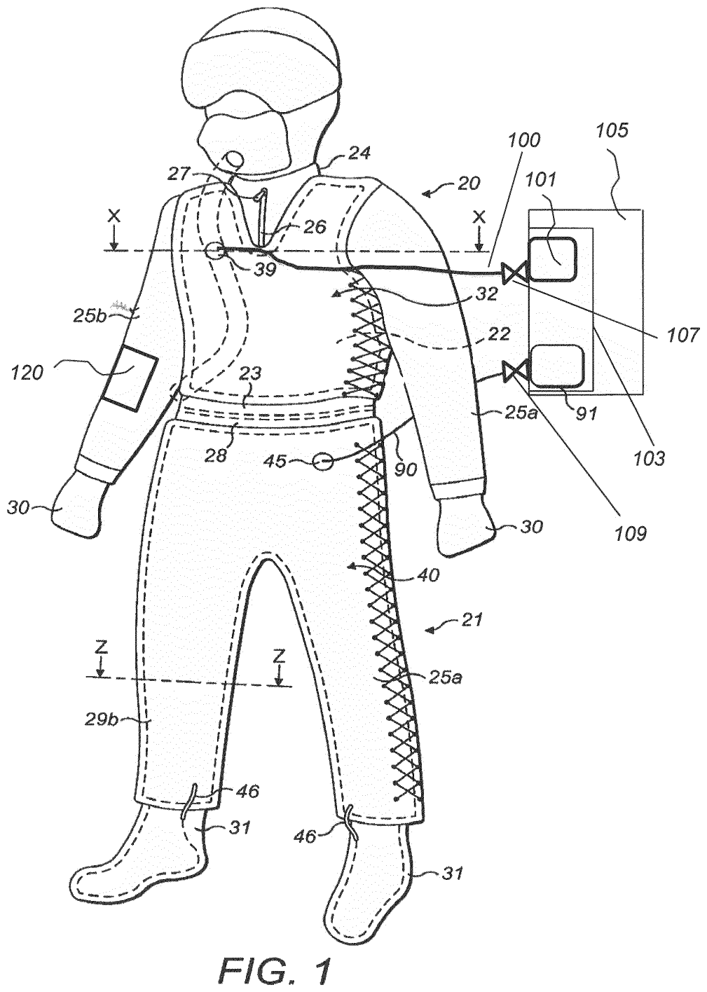

Referring first to FIG. 1, the aircrew ensemble includes a flight suit that comprises an upper suit portion 20 and lower suit portion 21. The upper suit portion 20 and the lower suit portion 21 are preferably made from an inherently fireproof fabric such as NOMEX®. The upper suit portion 20 has a torso portion 22, a waist 23, a neck opening 24 and left and right arm portions 25a, 25b, respectively. The upper suit portion also has a front opening 26 closed by, for example, a zipper 27. The lower suit portion 21 has a waist 28 and left and right leg portions 29a, 29b. The suit is completed by gloves 30 and boots 31.

The upper portion 20 and the lower portion 21 may be formed in one-piece with a front central longitudinal zip or may be formed as separate parts and connected at the waist.

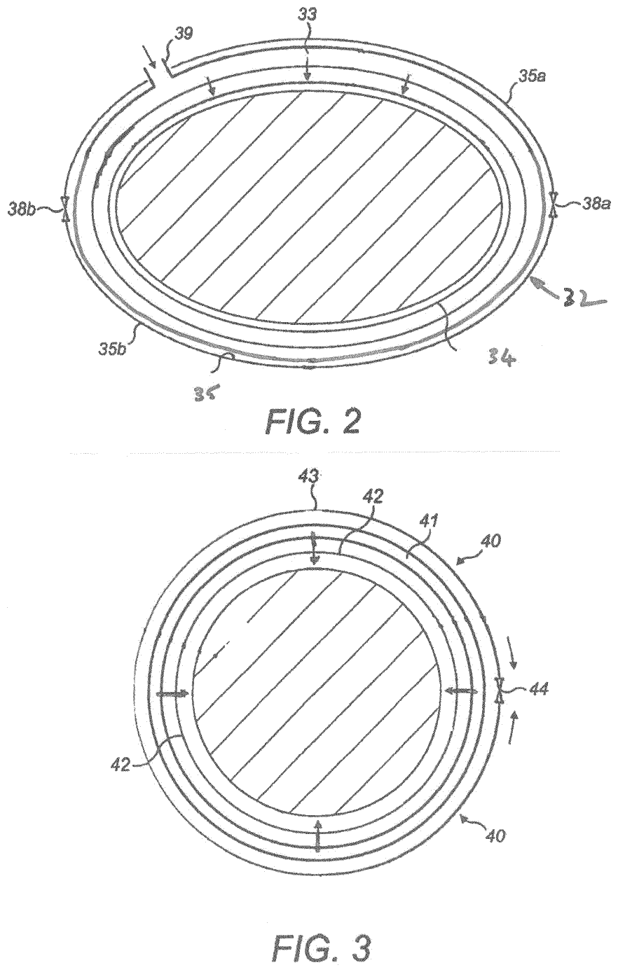

The upper portion 20 carries a chest counter pressure assembly in the form of a jacket 32 containing a chest counter pressure bladder 33. Referring next to FIG. 2, the jacket 32 is formed of inner and outer layers 34, 35 of air permeable material that hold the bladder 33 between them located on the chest 36 of a wearer. The inner layer 34 and/or the outer layer 35 of the jacket 32 may be elastically deformable. The inner layer 34 and/or the outer layer 35 of the jacket 32 may be inelastic and/or inextensible. Preferably at least the outer layer 35 of the jacket 32 is inelastic and/or inextensible.

As seen in FIG. 2, the outer layer 35 is formed by front and rear portions 35a, 35b that are interconnected by two rows of side lacing 38a, 38b located at respective opposite sides of the outer layer 35 to allow the circumferential length of the jacket 32 to be adjusted to the correct fit for a wearer, although such adjustment can be performed in other ways. This adjustment is important for reasons that will become apparent below. The bladder 33 is formed of an air-permeable material that allows air to pass through the material. The entire surface of the bladder 33 may be air permeable, or only part of the surface of the bladder 33 may be air permeable.

The bladder 33 has an inlet 39 for connection to an inflation hose 100 that, in turn, is connected to an inflation system 101 for supplying air under pressure to the bladder 33, in a manner to be described below. The inflation system 101 may be part of a breathing system 103 for the wearer. Both the inflation system 101 and the breathing system 103 may be part of the aircraft's pressurisation system 105.

Referring once again to FIG. 1, and also to FIG. 3, the lower portion 21 carries a lower G assembly 40 assembly a lower G bladder 41. The lower G assembly 40 is formed by inner and outer layers 42, 43 of air-permeable material that hold the lower bladder 41 between them and located around the legs of a wearer (one of which is shown in FIG. 3) and over the abdomen of the wearer. The inner layer 42 and/or the outer layer 43 of lower G assembly 40 may be elastically deformable. The inner layer 42 and/or the outer layer 43 of lower G assembly 40 may be inelastic and/or inextensible. Preferably at least the outer layer 43 of lower G assembly 40 is inelastic and/or inextensible.

As seen in FIG. 3, the outer layer 43 is formed with a side opening whose edges are interconnected by a row of side lacing 44 located to allow the circumferential length of the lower G assembly 40 outer layer 43 to be adjusted to the correct fit for a wearer, although such adjustment can be performed in other ways. This adjustment is important for reasons that will become apparent below. The bladder 41 is formed of air-permeable material that allows air to pass through the material. The entire surface of the bladder 41 may be air permeable, or only part of the surface of the bladder 41 may be air permeable. The bladder 41 has an inlet 45 for connection to an inflation hose 90 that, in turn, is connected to an inflation system 91 for supplying air under pressure to the bladder 41, in a manner to be described below. The inflation system 91 may be part of the breathing system 103 for the wearer.

The lower G bladder 41 has also an outlet 46 at each ankle connected to respective bladders (not shown) in respective boots 31.

In use, an aircrew member such as a pilot dons the suit with the jacket 32 and lower G garment 40. The lacings 38a, 38b and 44 are tightened to ensure that the jacket 32 and the garment 40 are a close fit around the torso and the lower body portion respectively of the wearer so that, when inflated, the bladders 33, 41 apply a required restriction (see below).

The inlet 39 to the chest bladder 33 is connected via a G valve 107 to the inflation system 101, as described above, which may also be part of the aircraft breathing circuit 103. The inlet 45 to the lower G bladder 41 is connected via a G valve 109 to the inflation system 91. Whilst in flight, the chest bladder 33 and the lower G bladder 41 are pressurised and depressurised through the aircraft's pressurisation system 105 and the G valves 107, 109. This happens as the aircraft experiences high G and the valves 107, 109 open and close at pre-determined values of G.

The inlet 39 to the chest bladder 33 and the inlet 45 to the lower G bladder 41 may alternatively both be connected to a single G valve and a single inflation system.

As mentioned above, the air holding bladders 33, 41 that are incorporated into an aircrew protective ensemble, for applying counter pressure when gas filled under high G acceleration, are made to be air-permeable. The passage of air through the air-permeable bladders 33, 41 advantageously assists in the cooling of the wearer as this will increase evaporative cooling from the surface of the wearer's body.

The bladders 33, 41 are made from a material that is porous to air when air is passed into them from a pressurised air supply source or can be a non-permeable material made porous (or air-permeable) by being punctured to form holes over its surface (e.g. “needled”). The extent of the porosity (or permeability) of the material is selected so that the air flow out of the bladders 33, 41 cannot be so excessive as to substantially reduce the effectiveness of the ability to of the bladders 33, 41 to apply pressure to the wearer's body when under high G.

Air-permeable regions of the bladders 31, 41 may, for example, have 3 mm diameter holes formed at 100 mm intervals along parallel rows. Adjacent rows may be spaced apart at 50 mm intervals. The holes along adjacent rows may be staggered so that a hole in a first row is equidistant from the two nearest holes of a second, adjacent row. The holes along alternate rows are aligned along axes perpendicular to the rows, the distance between adjacent holes along such an axis being 100 mm. An example hole arrangement is shown in FIG. 28.

A typical air flow rate of about 580 litres a minute may maintain a constant flow rate through the air permeable bladder to maintain a 0.5 psi (3447 Pa) internal pressure for cooling purposes. A higher internal pressure may be required when G protection is needed for the wearer. For example, a maximum bladder pressure needed at the maximum 9 G (e.g. 9 Gz, gravitational force that is applied to the vertical axis of the body) may be 11 psi (75.84 kPa). A lower bladder pressure may be sufficient at lower G forces; for example at 5 G (or 5 Gz) a bladder pressure of 4 psi (27.57 kPa) may be used.

The bladders 33, 41 may be made from material that is both moisture vapour permeable (as described in WO-A-2012/041971) as well as air permeable. Such moisture vapour permeable materials are available from GORE-TEX.

Respective regions of the bladders 33, 41 may have different levels of air-permeability. For example, regions of the bladders 33, 41 that cover larger muscles, such as thighs and calves, may have a greater air-permeability than other areas. Regions of the bladders 33, 41 that cover parts of the wearer's body that require maximum G protection, such as the abdomen, may have a lower air-permeability than other areas (such as the larger muscles). Regions of the bladders 33, 41 that cover parts of the wearer's body that require maximum G protection may not be air-permeable at all. The different air-permeabilities may be provided by varying the size and/or positioning of holes in the bladder material-e.g. with no holes at the abdomen area and a higher density of holes at the larger muscle areas than other areas.

The bladders 33, 41 are preferably inelastic (formed from inelastic material), although in some embodiments the bladders 33, 41 may be elastic (e.g. formed from elastically deformable material).

When in an aircraft is experiencing high G, the bladders 33, 41 are pressurised by the pressurisation system 105 which includes a pressurised supply of air on board the aircraft. This pressurised supply of air from the pressurisation system 105 is almost in practice unlimited in flow rate/volume. The pressurised supply of air can be therefore used to increase evaporative cooling in addition to the conventional purpose of providing high G protection.

The flow and volume of air from the pressurisation system 105 is configured to be sufficient that it still allows the bladders 33, 41 to be highly effective at protecting aircrew when under high G conditions, even though a relatively small amount of air is “leaking” out of the bladders 33, 41 due to their air permeability.

The pressurisation system 105 may also be modified to create a back pressure and controlled flow of air into the bladders 33, 41 when not under high G. As mentioned above, the supply of air into the bladders 33, 41 is controlled by a G valves 107, 109 such that, as high G is experienced the valves 107, 109 open to fully inflate the bladder 33, 41 to provide high G protection. The valves 107, 109 may be modified to allow an air flow into the bladders 33, 41 when not under high G to provide cooling of the wearer even under lower G conditions when the bladders 33, 41 are partially (not fully) inflated. This creation of an airflow into the bladders 33, 41 when not under high G has a further benefit as the bladders 33, 41 are always filled with air (albeit to a low pressure) such that, on experiencing high G, the time taken to fully inflate the bladders is reduced. This is advantageous as this results in the bladders filling quicker with air to quickly provide counter pressure earlier thus preventing “pooling” occurring in the lower limbs. Generally, the rate at which air passes through the air-permeable material of the bladders 33, 41 will be lower when the air pressure in the bladders 33, 41 is lower. Greater cooling is generally required at high G (when the bladders 33, 41 are fully inflated at high pressure) due for example to the stresses to which aircrew are subjected at high G—and therefore a relatively lover cooling effect at lower bladder pressures may be considered appropriate and advantageous.

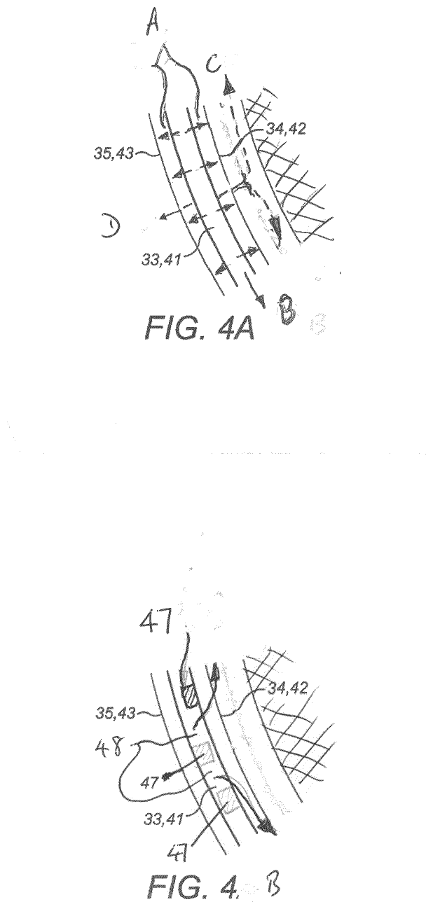

FIG. 4A shows a partial cross-sectional view through a portion of the upper 20/lower 21 portion of the flight suit. As indicated by arrows “A” air within the bladder 33, 41 passes through the outer and inner surfaces of the bladder due to the air permeability of the outer and inner surfaces of the bladder 33, 41. Arrow “B” shows movement of air within the bladder 33, 41 between the outer and inner surfaces of the bladder 33, 41. Arrow “C” shows movement of air through the inner surface of the bladder 33, 41, the inner surface 34 of the jacket 32/the inner surface 42 of the lower G assembly 40. Arrow “D” shows movement of air through the outer surface of the bladder 33, 41, the outer surface 35 of the jacket 32/the outer surface 43 of the lower G assembly 40. Only one of the outer and inner surfaces of the bladder 33, 41 may be air permeable.

FIG. 4B shows a partial cross-sectional view through a portion of the upper 20/lower 21 portion of the flight suit that includes optional formations 47 on the outer and inner surfaces of the bladder 33, 41, inside the bladder volume, which provide channels 48 for air to pass along within the bladder 33, 41. When the bladder 33, 41 are not fully inflated the outer and inner surfaces of the bladder may be compressed together by the tightening of the outer layers 35, 43 of the G garment, and the formations 47 assist the passage of air in this situation. The formations 47 may be square or rectangular in cross-section. The formations 47 may have a length of 2-3 mm and/or a width of 2-3 mm (measured parallel to the surface of the bladder 33, 41). The formations 47 may be formed of substantially incompressible (e.g. closed cell) foam. The formations 47 may be formed of rigid material, such as plastics. The use of formations 47 in the lower 21 portion of the flight suit may be particularly advantageous to improve the passage of air to prevent “pooling” occurring in the lower limbs. For example, a row of six formations 47 may be provided spaced apart along a line between the bladder 41 inlet 45 and outlet 46.

Optionally, a portable air pump 120 may be provided which may be carried by the aircrew member. The portable air pump 120 may be battery powered. The portable air pump 120 may be connected to the inlets 39, 45 to provide an air flow into the bladders 33, 41 when not under high G to provide cooling of the wearer even under lower G conditions when the bladders 33, 41 are not fully inflated such that when out of the aircraft the aircrew member can have the benefit of evaporative cooling caused by air passing through the air-permeable bladder material. This is advantageous as it addresses the challenge of keeping pilots cool when “standing by” for example on the deck of an aircraft carrier in the Gulf or other hot climate.

The upper 20 portion of the flight suit is sometimes not worn and in this case a bladder type garment/vest may be provided that is made from similar air-permeable materials to the lower G garment 21 and used as an upper body cooling garment. This may be done by using the low-pressure cooling air supply that is used to provide cooling to the lower body G garment 21, which is controlled by a valve which controls the pressure to ensure the pressure in the upper portion 20 is sufficient to provide cooling by the passage of air through the bladder but which pressure remains relatively low compared with the pressure applied provide G protection.

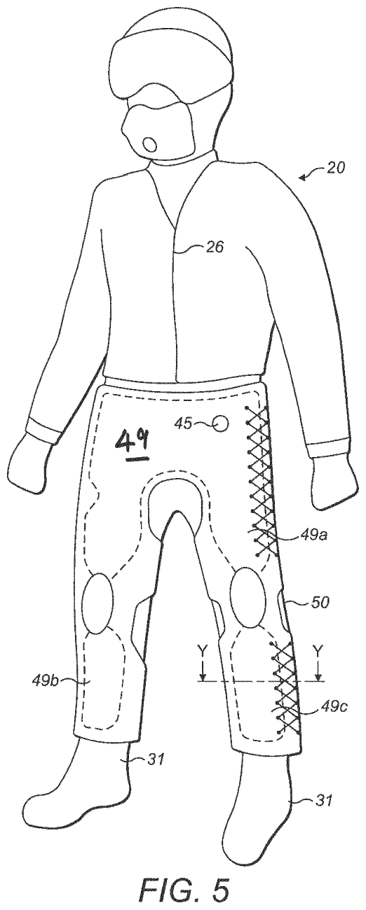

Referring next to FIG. 5, an alternative form of the lower G bladder has the lower G bladder 49 in the form of a partial cover bladder. Parts common to FIGS. 1 to 4 and to FIG. 5 are given the same reference numerals and will not be described in detail.

The partial cover lower G bladder 49 is formed by a first bladder portion 49a that extends across the front abdomen of a wearer and then down the front of the thighs of the wearer to just above the knee. Second and third bladder portions 49b, 49c extend over respective left and right shins of the wearer. These bladder portions 49a, 49b and 49c are interconnected and connected to a source of pressurised air as described above in relation to FIGS. 1 to 4. The bladder portions 49a, 49b and 49c are air-permeable to allow cooling of the wearer in the manner described above.

Referring next to FIG. 6, the shin bladders 49b, 49c extend only around the front of the leg 50 of the wearer. When the bladders 49b, 49c are inflated, the diameter of the outer layer 43 increases and so draws the non-elastic outer layer 43 against the rear of the leg 50 of the wearer. This, together with the pressure applied by the bladder 43b, 43c to the front of the leg, provides the constriction necessary to counter G forces.

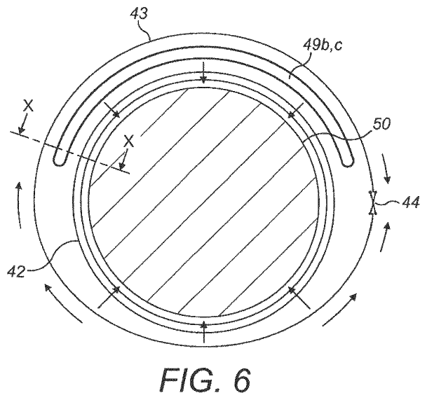

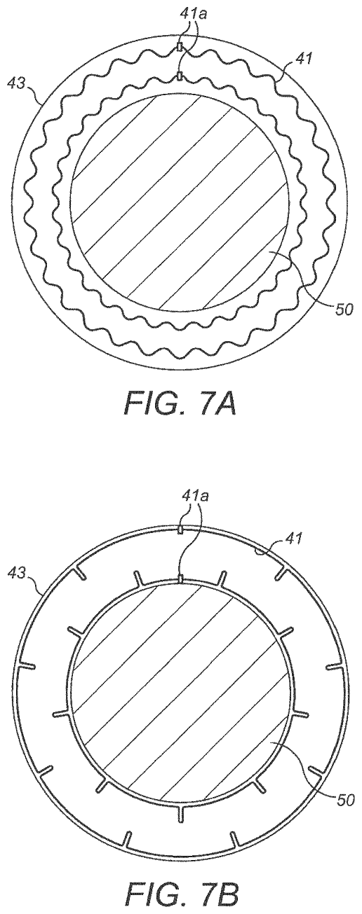

In the embodiments of FIGS. 1 to 4, the bladder 41 is sized to extend exactly around the associated body part. This need not be the case. If the material of the bladder 41 is inelastic, the bladder 41 may be sized so that when uninflated the bladder 41 is of greater diameter than the body part it encircles (see FIG. 7A). Thus, when inflated, the bladder 41 is not subject to hoop stress (see FIG. 7B) and the tension is taken up by the seams of the outer layer 43 and not by the seams 41a of the bladder 41, which are weaker than the seams of the outer layer 43.

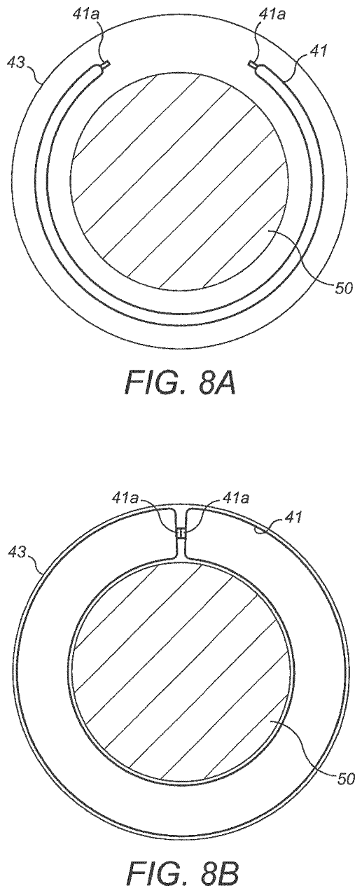

Alternatively, if the bladder 41 is made from an elastic material, it can be sized so that, when uninflated, it is of lesser diameter than the limb 50 it encircles so as to reduce the bulk of the garment (see FIG. 8A). When inflated (see FIG. 8B), the circumferential length increases to surround the limb 50.

The principles described above with reference to FIGS. 7A, 7B and 8A, 8B are not limited to bladders such as the lower G bladders 33, 41 that, when inflated, extend all around a body part. The same principle could be applied to other bladders, such as the chest compression bladder 33, by containing the bladder in a pocket formed in the associated garment. Where the bladder is of inelastic material (such as in FIGS. 7A, 7B), the pocket is smaller than the uninflated bladder so that, when inflated, the inflated bladder is confined by the pocket and tension is taken by the material of the garment. If the bladder is of elastic material (FIGS. 8A, 8B) then the pocket is larger then the uninflated bladder, with the bladder, on inflation, expanding to fill the pocket.

There are a number of ways of designing a bladder 33, 41 to reduce further the thermal burden. These can be used with or without the permeable materials previously described.

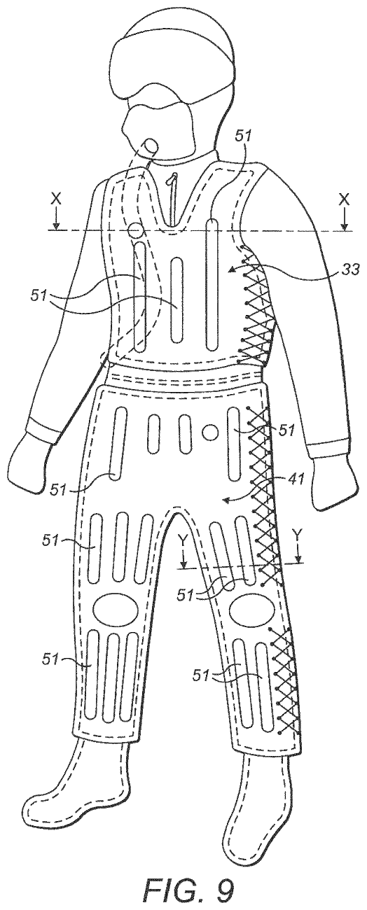

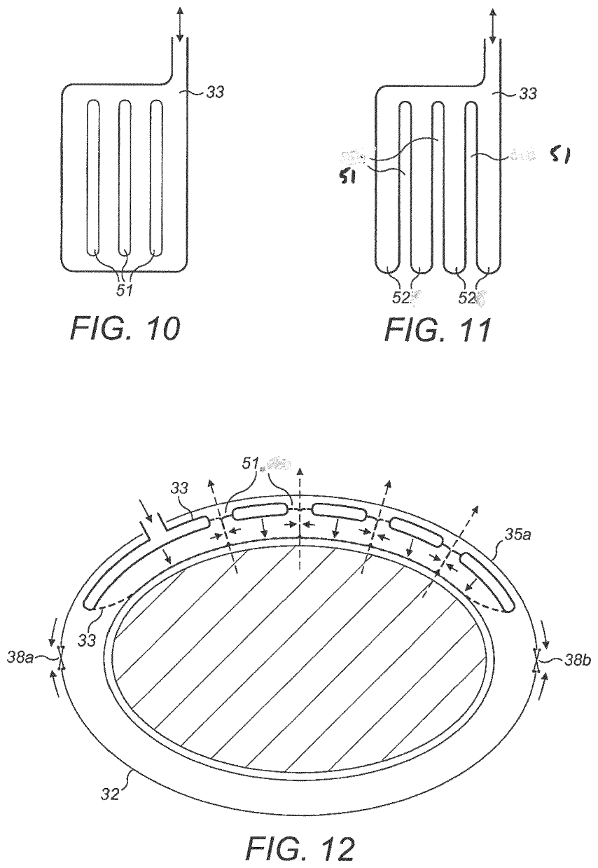

Referring next to FIG. 9, parts common to FIGS. 1 to 8 and to FIG. 9 are given the same reference numerals and will not be described in detail. In this embodiment, the chest bladder 33 and the lower G bladder 41 are provided with elongate slots 51 to form “grill” bladders 33, 41—seen schematically in FIG. 10. Alternatively, as seen schematically in FIG. 11, the bladders 33, 41 can be formed as a series of inter-connected bladder tubes 52 (“fingers”) connected by a manifold such that there are spaces formed by bladder slots 51 between the fingers 52. The slots 51 allow air movement through the slots 51 when the bladder 33, 41 is deflated and therefore evaporative cooling of sweat is assisted when uninflated. This is shown in more detail in FIG. 12 for the chest bladder 33 where it will be seen that, when the bladder 33 is uninflated, evaporative cooling can take place through the slots 51. The “grill” bladders 33, 41 and bladder tubes 52 (“fingers”) are formed of air-permeable material to provide cooling.

However, when inflated, the bladder 33, 41 expands laterally and outwardly to provide the continuous counter-pressure needed (seen in broken line in FIG. 12 for the chest bladder 33 and in FIGS. 13A (uninflated) and 13B (inflated) for the lower G bladder 41).

In these embodiments, therefore, the bladder 33, 41 has an uninflated area and is formed, inwardly of the periphery of that area, with one or more open gaps that allow air movement through the gap or gaps to increase evaporative cooling. The or each gap closes or substantially closes on inflation of the bladder 33, 41.

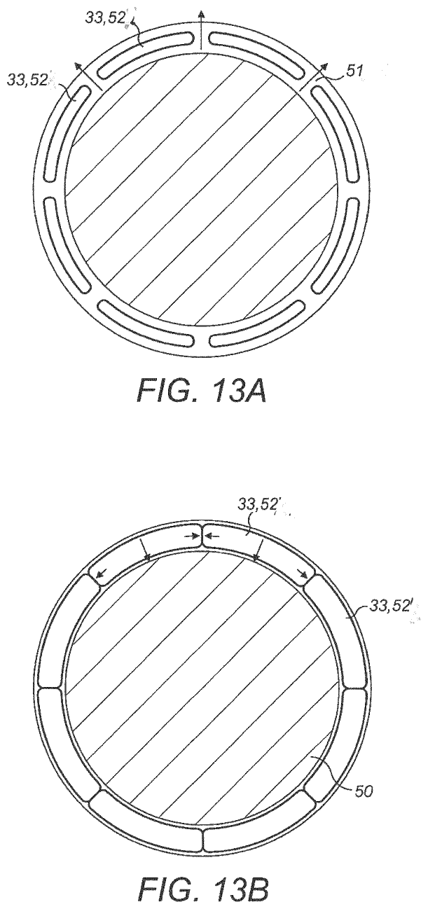

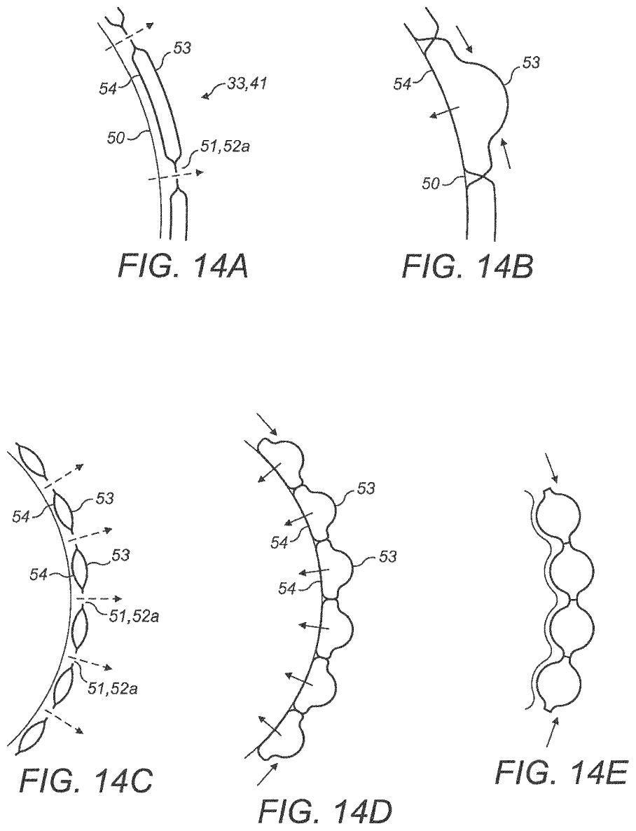

Referring next to FIG. 14A to 14E, the grill or finger bladders 33, 41 can be made with an outer layer 53 of non-stretch material and an inner layer 54 of elastic material. When such a bladder 33, 41 is inflated, the outer layer 53 will bulge (because it is non-stretch) and so reduce the circumferential length of the bladder 33, 41. The inner layer 54 will stretch (rather than bulge) and so apply even pressure to the flesh (see FIGS. 14B and 14D). This helps to reduce a problem of traditional G bladders made wholly of non-stretch materials that, when they are inflated, the cover of the bladder “balloons” both inwardly and outwardly. This “ballooning” causes restriction in the cockpit due to the bulk of the inflatable section increasing and can interfere dangerously with the pilot controls. This effect is greatly reduced in this dual material “finger” or “grill” bladder design. It is only by the inner layer 54 being elastic that the inner/internal space is filled and the pressure surface is then applied evenly to the body part. If this is not applied evenly then this leads to petechial haemorrhaging (see FIG. 14E) where the surface vessels burst under the skin in the areas where uneven pressure produces areas of insufficient pressure to counteract the increased internal pressure in the vessels.

In the embodiments described above with reference to FIGS. 1 to 14, the bladders 33, 41, 49 are all carried between inner and outer layers 34, 35 and 42, 43 of a jacket 32 or lower G garment 40. In the case of partial cover bladders 49a, 49b and 49c, the bladders 49a, 49b and 49c may be secured by, for example, stitching to the outer layer 43, although this is not necessary.

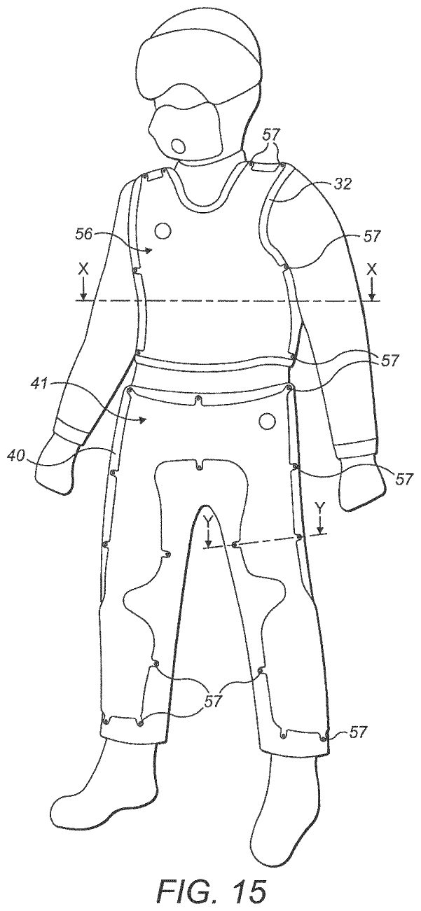

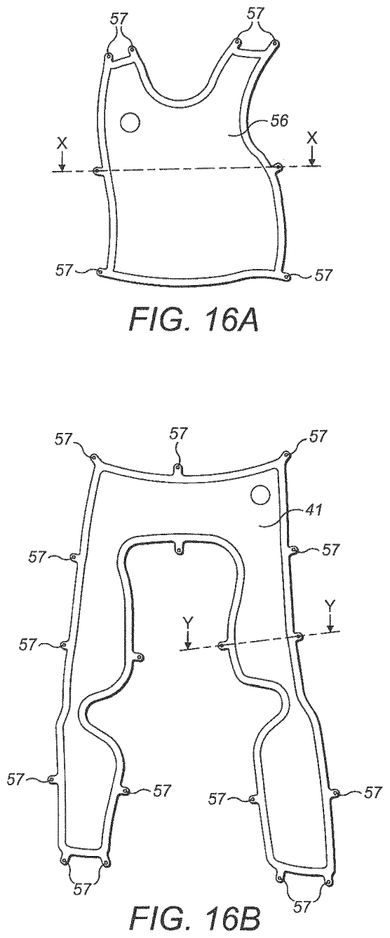

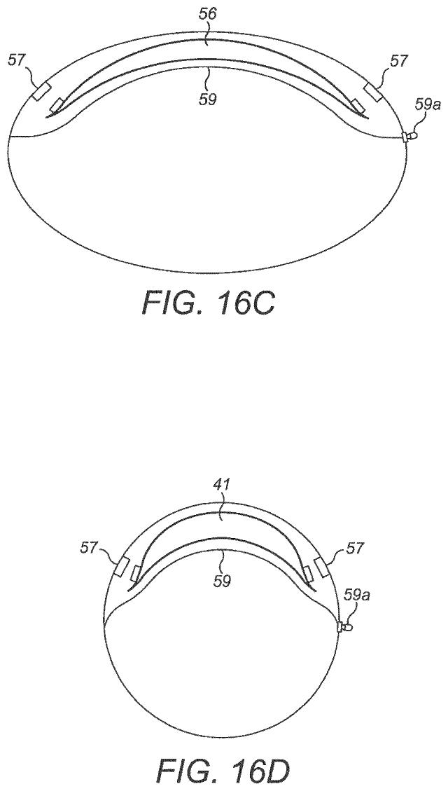

Referring next to FIGS. 15 and 16A, 16B, 16C and 16D, parts common to these Figures and to FIGS. 1 to 14 are given the same reference numerals and will not be described in detail. In this embodiment, the jacket 32 and the lower G garment 40 are formed from a single layer of air-permeable material. The chest bladder is formed by a single front air-permeable bladder 56 that is attached to the jacket 32 by releasable fastenings 57 such as press studs or touch close fasteners or zippers or other mechanical means (see FIG. 16B). Similarly, the lower G air-permeable bladder 41 is attached to the lower G air-permeable garment 40 by releasable fastenings 57 such as press studs or touch close fasteners or zippers or other mechanical means (see FIG. 16B).

As seen in FIGS. 16C and 16D, the bladders 56, 41 may be covered with an inner lining 59 that forms a pocket with the associated garment that can be opened at one side 59a to allow insertion of the bladder 56, 41.

If the bladders 33, 41 of the suit described above with reference to FIGS. 1 to 14 are damaged or punctured, then the suit becomes non-functional and normally has to be replaced in its entirety or has to be stripped down into component parts and reassembled when the faulty part is replaced. The bladders 33, 41 may need to be taken apart and then replaced as the suit is being rebuilt. The bladders 33, 41 are particularly vulnerable to damage caused by wear and tear as they are constantly being inflated and deflated and being worn in a suit in which mechanical action inside the cockpit can easily damage the bladders 33, 41.

The arrangement of FIGS. 15 and 16A, 16B, 16C, 16D, in which the bladders 56, 41 are of modular design such that they can be easily replaced or exchanged by hand and without any special tools, reduces substantially the cost of servicing and maintenance of such bladder counter pressure systems. In addition, it allows the ensemble to be worn either with or without bladders 56, 41 so making the ensemble more widely functional.

The feature of removable bladders of FIGS. 15 and 16 can also be used in conjunction with the bladders 33, 41 of the full cover suit of FIGS. 1 to 4.

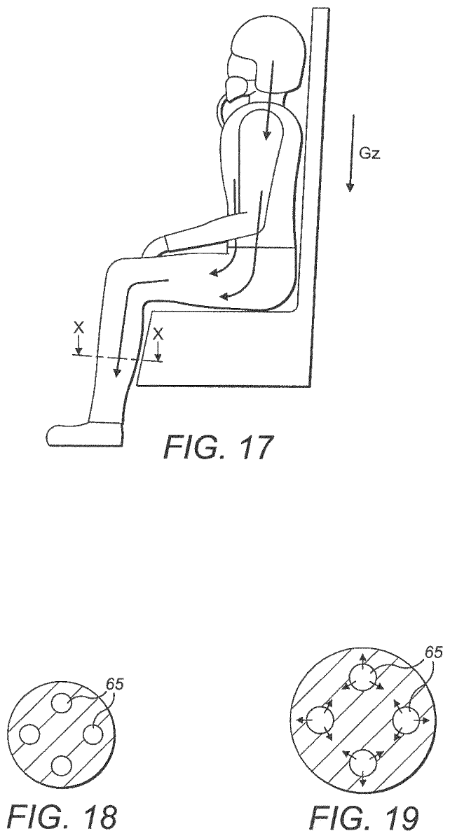

Referring next to FIGS. 17, 18, 19 and 20, when an aircrew in an aircraft that experiences high G_{z} acceleration is subjected to high G forces when in a curved flight, then the body fluids (in particular the blood, more particularly venous blood) are accelerated in the z direction (i.e. from head to toe) (see FIG. 17). As the mass of the fluid is increased by the acceleration, so the hydrostatic pressure of the fluid is increased progressively and linearly in the z direction (see also FIG. 17). As the walls of human blood vessels 65 are essentially “elastic”, then the volume of the vessels 65 is increased in the z direction progressively and linearly i.e. in the lower limbs (see FIGS. 18 and 19). As a consequence of this, the volume of blood overall is increased in the lower limbs (blood pooling) and decreased in the upper part of the abdomen as the volume of blood in the body is constant. Decreasing the volume of blood in the upper part of the abdomen also leads to a decrease of blood volume in the head. At the same time as the blood is being accelerated in the z direction, the heart, aorta and other large vessels of the abdomen are also displaced in a z direction which adds to a further reduction in the total blood volume in the upper part of the body and therefore in the head. (This is known as the caudal effect.) As a consequence of reducing the available blood pressure and volume in the brain (and in particular the supply of blood to the eyes), a dangerous lowering of the blood oxygen concentration in the brain occurs. This leads first to a loss of colour in the vision and then a loss of peripheral vision (grey out and tunnel vision). Ultimately G induced loss of consciousness (GLOC) occurs. This clearly has a detrimental effect on the aircraft pilot and ultimately the loss of the aircraft and the death of the aircrew may follow.

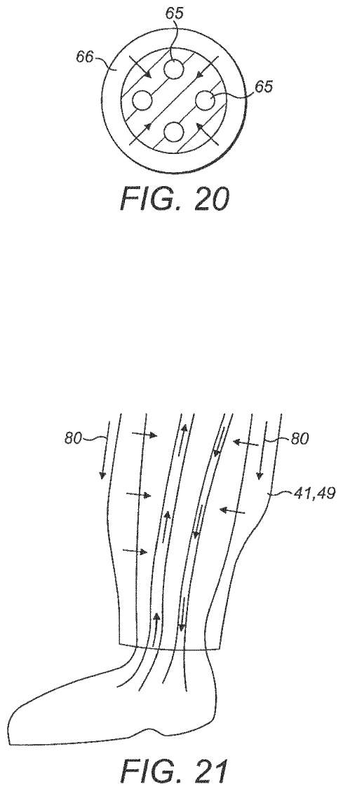

To counteract this negative affect of blood pooling in the lower limbs, counter pressure garments to cover the lower limbs have been developed as described above and, for example, with reference to FIGS. 1 to 16 and in WO 2007/111981 and US-A-6325754. As seen in FIG. 20, the effect of such a garment 66 is to restrict the leg blood vessels 65 and so force blood back into the upper part of the body.

As well as the use of counter pressure garments, aircrew are trained to carry out physiological manoeuvres (Anti-G Straining Manoeuvres—AGSM) and this is done by tensing the voluntary muscles and pressurising the chest/lungs, the action of both of these being to reduce the effect of G acceleration on the body. This is, however, very tiring and limits the G endurance that can be tolerated and it also limits voice communication and voice command whilst straining under AGSM. The goal of a G protection garment and its development is to limit the amount of pilot effort required by maximising the protection offered by the garment and therefore increasing overall G endurance. Additionally, pilots can also breathe pressurised gas (Positive Pressure Breathing for G, PPBG) such that the thoracic pressure/thoracic blood pressure is increased causing more dissolved oxygen to be carried to the brain.

One type of counter pressure (anti-G) garments is gas pressurised by inflating gas holding bladders from an aircraft compressor or compressed gas supply and which are restrained around the lower limbs and lower abdomen by covers which apply a counter pressure as described above with reference to FIGS. 1 to 16 and therefore limit the “blood pooling” in the lower limbs and limit the z displacement of the heart and major blood vessels (caudal effect) (see FIG. 20). Referring next to FIG. 21, in such a suit, an inflation pressure front 80 travels down the lower G bladder 41, 49, moving in a direction opposite to that of the venous blood to apply the pressure to the leg (see also FIG. 20) that limits blood pooling.

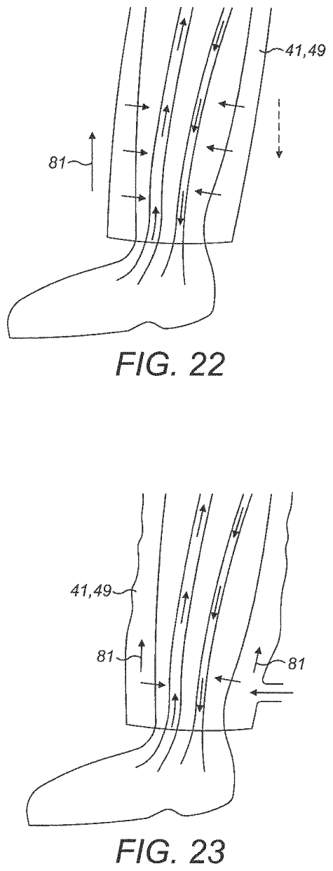

Referring next to FIGS. 22 and 23, the suit described above with reference to any of FIGS. 1 to 20 may be modified so that the air supply applies the gas inflation/pressurisation to the lower G bladder 41, 49 at the ankles first (“ankle inflation”) rather than applying the pressure first at the abdominal level. This benefits the wearer by tending to increase the venous blood return up the lower limbs and thereby increasing the blood volume/pressure in the upper body and head. The pressure point 81 from the applied air thus starts at the ankle (see FIG. 22) and continues up the leg (see FIG. 23) in the same direction as the venous blood until the bladder reaches an operating pressure.

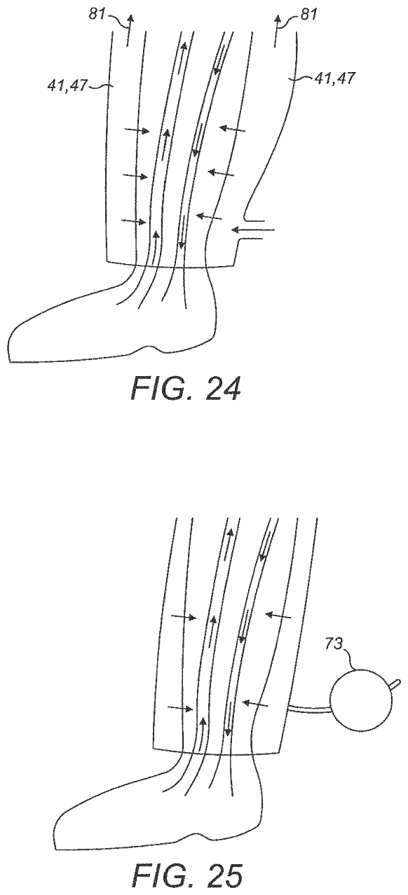

In addition, the air supply may be modified to apply continuously a residual “gas pressure” to the lower G bladders 41, 49 and thus constriction to the lower limbs such that blood pooling is continuously reduced in the lower limbs. (This is termed “start-pressure” and is less than the operating pressure.) This is shown in FIGS. 24. This benefits the wearer by continuously reducing blood pooling and overcomes the “lag” phase in the G garment inflation system. This may be supplied automatically or may be controlled by the wearer utilizing a squeezable bulb 73 (see FIG. 25).

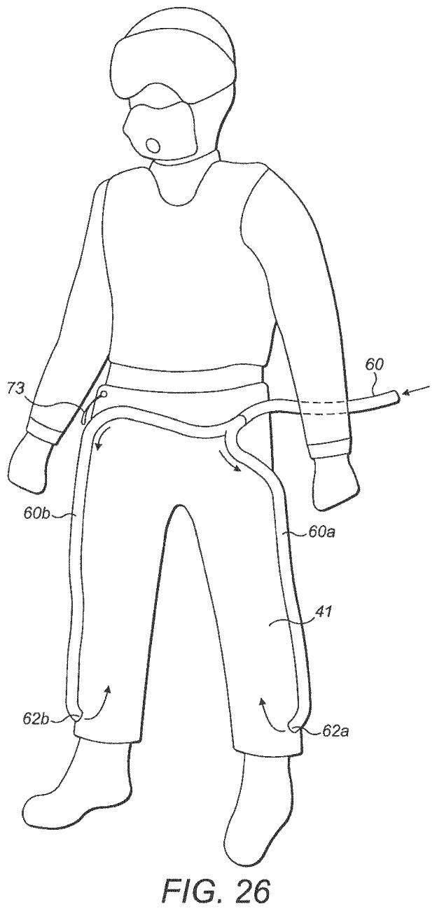

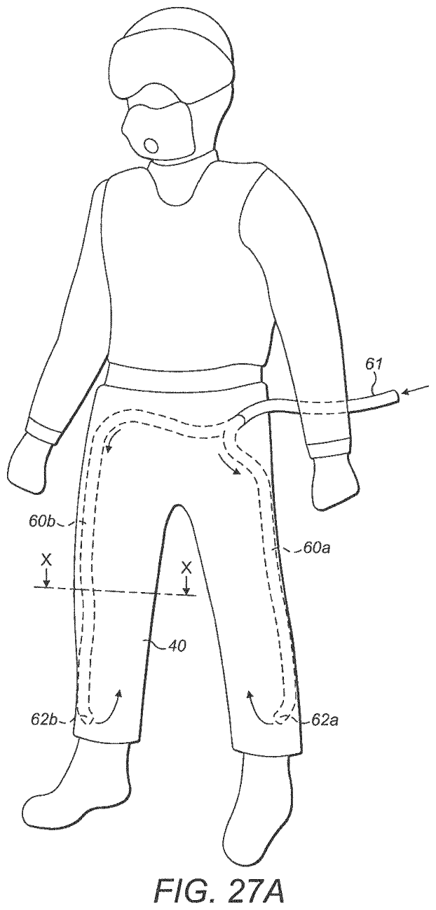

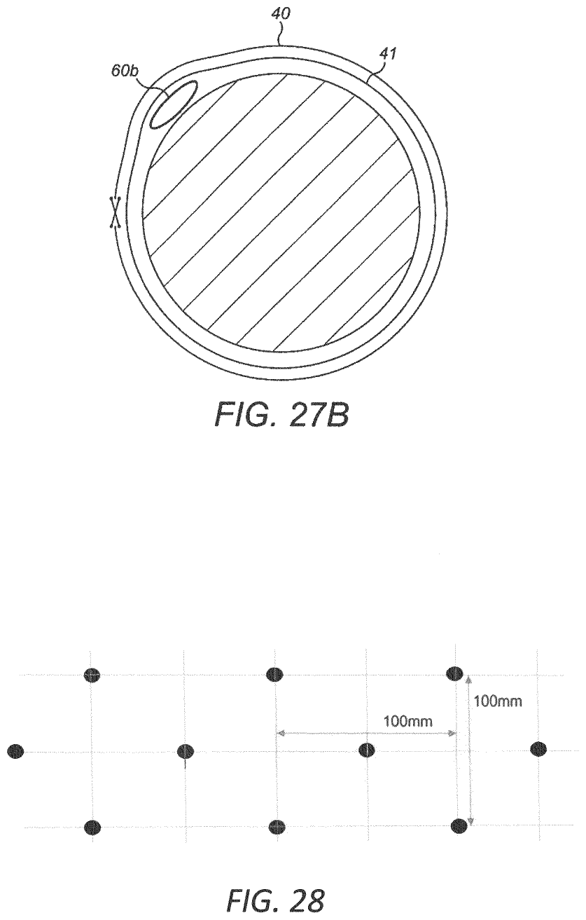

Referring next to FIG. 26, the air supply to the ankles may be through two external hoses 60a and 60b connected by a single hose 61 to the air supply. Each hose 60a, 60b runs along a respective leg of the lower G garment 41 to a respective inlet 62a, 62b at an associated ankle. Alternatively, as seen in FIGS. 27A and 27B, the hoses 60a, 60b may run through the interior of the lower G bladder 41 (see FIG. 27B) to the respective inlets 62a, 62b.

Although the bladders above are described as air-permeable, it should be appreciated that the bladders may be gas-permeable-and not specifically permeable by air. The bladders may be permeable by any gas that is used to inflate the bladders-allowing a portion of the inflating gas to permeate through the bladder walls. Air is a convenient gas to use, as it is often stored onboard an aircraft to help aircrew breathe; however, other gases can be used to inflate the bladders.

1. An inflatable bladder configured to be carried by an aircrew garment worn on the body of the aircrew and to apply pressure to the body when inflated by a gas to counteract effects of high G-forces during flight, wherein the bladder includes a gas-permeable material allowing the passage of the gas therethrough to cool the body.

2. The bladder of claim 1, configured to control the maximum rate of passage of the gas therethrough such that the bladder remains sufficiently inflated to counteract effects of high G-forces during flight.

3. The bladder of claim 1, including a plurality of formations on an internal surface thereof to facilitate passage of the gas between the formations.

4. The bladder of claim 1, wherein the bladder includes a plurality of regions, each having a different gas-permeability.

5. An aircrew ensemble comprising a garment for covering at least a part of a body of a wearer and an inflatable counter-pressure bladder, carried by the garment, the inflatable counter-pressure bladder being formed from a gas-permeable material allowing the passage therethrough of gas to cool the wearer's body.

6. An ensemble according to claim 5 further comprising an inflation system configured to inflate the bladder when a threshold G-force is detected acting on the wearer's body, the inflation system also being operable in the absence of said threshold G-force to cause gas to pass through the gas-permeable material of the bladder to increase the cooling of the wearer's body.

7. An ensemble according to claim 5 wherein the garment includes at least one layer of inextensible material, inflation of the bladder causing the bladder to act against the at least one layer to apply counter-pressure to the wearer's body.

8. An ensemble according to claim 5, wherein the garment includes two layers, the inflatable bladder being located between said two layers.

9. An ensemble according to claim 5, wherein the inflatable bladder comprises a chest compression bladder and the garment is configured to cover a torso of a wearer.

10. An ensemble according to claim 5, wherein the inflatable bladder comprises a lower G bladder and the garment is configured to cover an abdomen and legs of a wearer.

11. An ensemble according to claim 10 wherein the lower G bladder is configured to extend across the abdomen and around the legs of the wearer.

12. An ensemble according to claim 10 wherein the lower G bladder includes a first portion configured to extend over the abdomen and thighs of a wearer and second portions configured to extend over respective shins of the wearer.

13. An ensemble according to claim 5, wherein the bladder comprises an elastic material so that, when the bladder is deflated, the bladder extends only partially over an associated body part of a wearer to allow evaporative cooling from the uncovered body part, inflation of the bladder causing elastic lengthening of the bladder to extend the bladder over the whole area of the associated body part.

14. An ensemble according to claim 5, wherein the bladder comprises an inelastic material, the bladder having an area greater than an area of an associated body part of the wearer and being confined by the garment so that, when inflated, the bladder has the area of the associated body part, so that the material of the bladder is untensioned, the tension being taken by the garment.

15. An ensemble according to claim 13 wherein the bladder comprises a lower G bladder, and the associated body part is a leg of a wearer, and the area is the circumference of the leg.

16. An ensemble according to claim 5, wherein the bladder includes a plurality of regions, each having a different gas-permeability, wherein a one of the regions with a relatively low gas-permeability is located to be positioned in use at a region of the wearer's body that requires greater protection from G forces.

17. A method of protecting aircrew, including providing an inflatable bladder configured to be carried by an aircrew garment worn on the body of the aircrew, wherein the bladder includes a gas-permeable material, and applying gas pressure to the bladder to cause the passage of the gas therethrough to cool the body of the aircrew.

18. The method of claim 17, wherein applying gas pressure to the bladder applies pressure to the body of the aircrew when inflated by the gas to counteract effects of high G-forces during flight.
